(19) United States
(12) Patent Application Publication
(10) Pub. No.: US 2009/0063227 A1
(43) Pub. Date: Mar. 5, 2009

(54) System and Method for Providing Advertisements in Connection with Tags of User-Created Content

(75) Inventors: Jin Wan Choi, Kyunggi-do (KR); Young-hoon Jun, Kyunggi-do (KR)

Correspondence Address: BAKER BOTTS L.L.P., 2001 ROSS AVENUE, 6TH FLOOR, DALLAS, TX, 75201, US

(73) Assignee: Yahoo! Inc., a Delaware Corporation

(21) Appl. No.: 11/966,336

(22) Filed: Dec. 28, 2007

(30) Foreign Application Priority Data
Aug. 27, 2007 (KR) 10-2007-85968

(51) Int. Cl. G06Q 30/00; G06Q 10/00; G06F 7/06; G06F 17/30

(52) U.S. Cl. 705/7; 705/14; 707/5; 707/E17.017

(57) ABSTRACT

There is provided a system for providing advertisements in connection with tags of user-created content. The system includes: a request receiving unit configured to receive a request for user-created content from a client terminal, wherein the user-created content includes non-text information; a content reading unit configured to read the user-created content according to the received request; a tag retrieval unit configured to retrieve tags of the read user-created content; an advertisement searching unit configured to search advertisements connected to the retrieved tags; and a transmission unit configured to transmit the read user-created content and the searched advertisements to the client terminal. When using the above system, it is possible to provide advertisements having higher relevancy with the content. Further, it is possible to provide advertisements having relevancy with even the content that includes the non-text information.

### TECHNICAL FIELD

The present disclosure generally relates to systems and methods for providing advertisements, and more particularly to systems and methods for providing advertisement in connection with tags of user-created content.

### BACKGROUND

Recently, the importance of content created by general users (instead of companies or professional content creators) has been recognized. Such content is generally referred to as user-created content (UCCs). However, since the generation of the user-created content has sporadically occurred, various methods have been conceived to efficiently classify and search the user-created content. As one of the methods, attachment of tags, or tagging, has been widely introduced.

Tags include keywords or categories assigned to a piece of information to be tagged as meta-data. Unlike typical categorization systems, multiple tags can be attached to one piece of information, thereby showing relevancy from a variety of viewpoints. Information or data assigned to the tags can be easily searched, exposed and categorized. They can also be combined with other data to form a data network. Tags can be attached generally by a person that creates, understands or retrieves the data. Thus, tags can have a relatively unrestricted format and can be recorded from a subjective viewpoint. In other words, tags can be considered as dynamic, flexible and contextual metadata information. Further, the content may not include the keywords used as the tags. By attaching the tags, it becomes possible to search information objects like music, pictures and photographs, which are not recorded in the text and thus are difficult to be searched, by a text input.

Further, there has been employed a service that exposes advertisement in response to the content of a received e-mail. For example, the G-mail service can be mentioned as such a service. The service displays advertisement relevant to the flower delivery (e.g., a hyperlink to a flower deliverer's website) at the right portion of the screen when an e-mail includes the phrase “flower delivery” in its text. Such a method, in which text of a received e-mail is referred to and advertisement in connection with a word or phrase contained in the text is displayed when a user reads the e-mail, is more efficient than conventional indiscriminate advertisement methods. However, the method is useless for content that is not comprised of text. Further, even if the content is comprised of text, the word or phrase contained in the text may be different from the intended meaning. For example, an e-mail including the phrase “flower delivery” may be actually asking for presents other than the flower delivery. In such a case, the service provides inappropriate advertisement, which does not fit the content.

### SUMMARY

In accordance with one aspect of the present invention, a system for providing advertisements in connection with tags of user-created content is provided. The system, in one particular implementation, includes: a request receiving unit configured to receive a request for user-created content from a client terminal, wherein the user-created content includes non-text information; a content reading unit configured to read the user-created content according to the received request; a tag retrieval unit configured to retrieve tags of the read user-created content; an advertisement searching unit configured to search advertisements connected to the retrieved tags; and a transmission unit configured to transmit the read user-created content and the searched advertisements to the client terminal.

In accordance with another aspect of the present invention, a system for providing advertisements in connection with tags of user-created content is provided. The system includes: a request-for-advertisement receiving unit configured to receive a request for advertisements related to user-created content from a client, wherein the user-created content includes non-text information; a tag retrieval unit configured to retrieve tags of the user-created content based on the received advertisement request; an advertisement searching unit configured to search advertisements connected to the retrieved tags; and a transmission unit configured to transmit the searched advertisements to the client.

In accordance with yet another aspect of the present invention, a client terminal configured to receive advertisements connected to tags of user-created content is provided. The client terminal includes: a content requesting unit configured to request for user-created content from a first server, wherein the user-created content includes non-text information; a content receiving unit configured to receive the requested user-created content; an advertisement requesting unit configured to request for advertisements related to the received user-created content to a second server; and an advertisement receiving unit configured to receive the advertisements related to the user-created content.

In accordance with still yet another aspect of the present invention, a method for providing advertisements in connection with tags of user-created content is provided. The method includes: receiving a request for user-created content from a client terminal, wherein the user-created content includes non-text information; retrieving tags of the requested user-created content; searching advertisements connected to the retrieved tags; and providing the searched advertisements to the client terminal.

In accordance with yet another aspect of the present invention, a method for providing advertisements in connection with tags of user-created content is provided. The method includes: receiving a request for advertisements related to user-created content from a client, wherein the user-created content includes non-text information; retrieving tags of the user-created content based on the received advertisement request; searching advertisements connected to the retrieved tags; and providing the searched advertisements to the client.

### BRIEF DESCRIPTION OF THE DRAWINGS

FIG. 1 shows an exemplary network environment in which a first embodiment of the present invention is practiced.

FIG. 2 illustrates a configuration of a server system in accordance with a first embodiment of the present invention.

FIG. 3 depicts a configuration of an advertisement statistic server in accordance with a first embodiment of the present invention.

FIG. 4 presents an example of a method for providing advertisement in accordance with a first embodiment of the present invention.

FIG. 5 describes another example of a method for providing advertisement in accordance with a first embodiment of the present invention.

FIG. 6 shows an example of a routine related to an advertisement statistic in a method for providing advertisement in accordance with a first embodiment of the present invention.

FIG. 7 sets forth another example of a routine related to an advertisement statistic in a method for providing advertisement in accordance with a first embodiment of the present invention.

FIG. 8 illustrates an exemplary network environment in which a second embodiment of the present invention is practiced.

FIG. 9 shows a plurality of functional modules in a client terminal, which are relevant to user-created content and advertisement, in accordance with a second embodiment of the present invention.

FIG. 10 illustrates a configuration of a server system for providing content in accordance with a second embodiment of the present invention.

FIG. 11 depicts a configuration of a server system for providing advertisements in accordance with a second embodiment of the present invention.

FIG. 12 illustrates a method for providing advertisements in accordance with a second embodiment of the present invention.

### DESCRIPTION OF EXAMPLE EMBODIMENTS

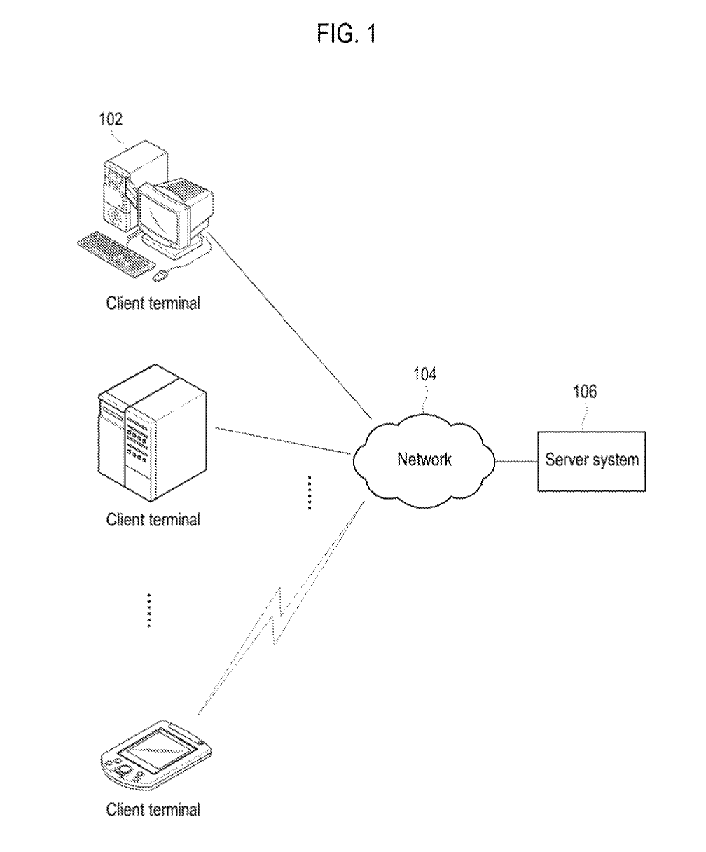

Various embodiments of the present invention will be described in detail below with reference to the accompanying drawings. FIG. 1 shows an exemplary network environment in which a first embodiment of the present invention is practiced. Referring to FIG. 1, client terminals 102 communicate with a server system 106 through a network 104 such as the Internet. The client terminals 102 may send a request message for, e.g., particular user-created content. Further, the server system 106 provides the requested user-created content to the client terminal 102 through the network 104 in response to the request message. The client terminals 102 may include, e.g., a personal computer, a workstation, a portable digital assistant (PDA), a cellular phone, a portable media player (PMP) and the like. However, the client terminals 102 are not limited thereto since any devices capable of receiving advertisement can be used in the present invention. The network 104 may include wired networks such as a local area network (LAN), a wide area network (WAN), a metropolitan area network (MAN), an integrated service digital network (ISDN) and the like, as well as wireless networks such as a wireless LAN, a code division multiple access (CDMA) network, a Bluetooth network, a satellite communication network and the like. However, the present invention is not limited to the enumerated networks.

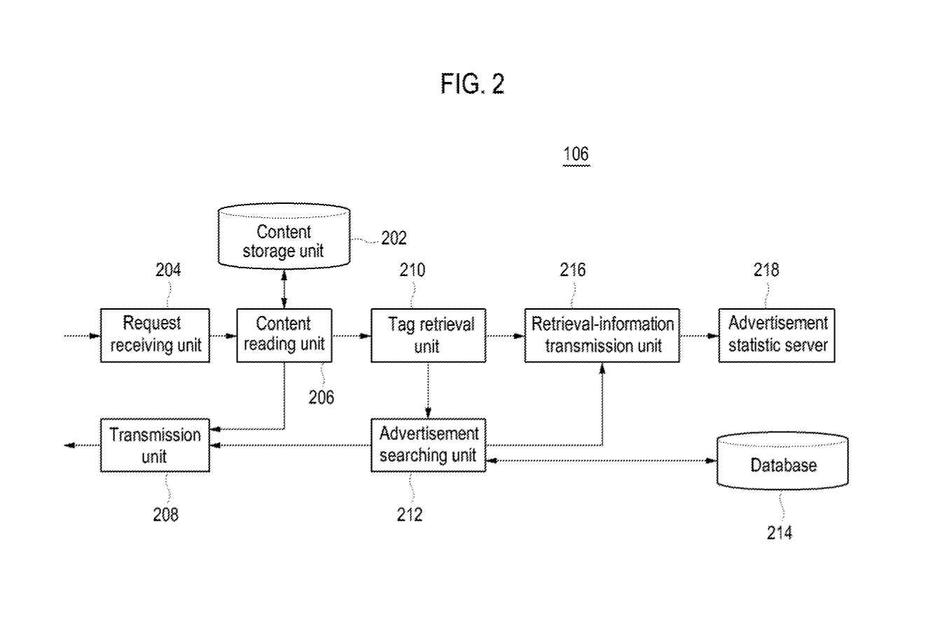

FIG. 2 shows a configuration of a server system in accordance with the first embodiment of the present invention. Referring to FIG. 2, the server system 106 includes a content storage unit 202 that stores user-created content and a request receiving unit 204 that receives a request for user-created content from the client terminal 102. The server system 106 further includes: a content reading unit 206 that reads the user-created content from the content storage unit 202 according to the request received at the request receiving unit 204; and a transmission unit 208 that transmits the user-created content, which are read from the content storage unit 202 by the content reading unit 206, to the client terminal 102 that requested the user-created content. The user-created content may include text information and/or non-text information. More specifically, the user-created content may have a variety of formats including text (simple text, Microsoft Word document, Wiki document and the like), pictures (bitmap, GIF, TIFF and the like), photographs (JPEG and the like), music (wave, MP3, OGG, WMA and the like), moving pictures (MPEG, AVI, WMV and the like) or combinations thereof. However, the present invention is not limited to the enumerated formats.

The server system 106 further includes a tag retrieval unit 210 that retrieves tags attached to the user-created content read by the content reading unit 206 and an advertisement searching unit 212 that searches advertisement corresponding to the tags retrieved by the tag retrieval unit 210. The transmission unit 208 may be used to provide the advertisement searched by the advertisement searching unit 212 to the client terminal 102. The advertisement may have a variety of formats including text, images, moving pictures or combinations thereof. If required, the advertisement provided from the advertisement searching unit 212 can be merged with the user-created content provided from the content reading unit 206 at the transmission unit 208. In such a case, the advertisement and the user-created content can be provided to the client terminal 102 in an integrated manner. In order to search the advertisement corresponding to the tags, the advertisement searching unit 212 may communicate with a database 214 that stores connection information between the tags and the advertisement. Although the database 214 is included in the server system 106 in FIG. 2, it is also possible to locate the database 214 out of the server system 106. Further, in order to calculate a statistic related to providing the advertisement, the tag retrieval unit 210 or the advertisement searching unit 212 may provide information of the retrieved tags or information of the searched and provided advertisement to an advertisement statistic server 218 through a retrieval-information transmission unit 216.

The tag retrieval unit 210 in accordance with the present embodiment retrieves the tags attached to the user-created content. The tags may be attached by a user (user tag). For example, a user who created the user-created content may attach appropriate tags when the user records the user-created content in the server. Alternatively, a user or users provided with the user-created content may suggest appropriate tags for the user-created content. The tags can also be attached by a system when the user-created content is recorded (system tag). In such a case, the system may extract appropriate keywords from the user-created content and tag the keywords to the user-created content. The system may categorize the tags or may maintain sets of similar tags. In such a case, the system may provide the same or similar advertisements for the similar tags or the tags in the same category. Multiple tags can be attached to one piece of the user-created content and the attached tags can be modified or changed. The tags can be maintained as separate data, which is connected to the user-created content by some connection information. In such a case, a database can be used to store the connection information between the user-created content and the tags. The tags attached to the user-created content in such a manner is retrieved by the tag retrieval unit 210, which then provides the retrieved tag information to the advertisement searching unit 212.

The advertisement searching unit 212 searches the advertisement corresponding to the tags provided from the tag retrieval unit 210. In one embodiment, the advertisement searching unit 212 provides the tag information, which is provided from the tag retrieval unit 210, to the database 214 that which stores the connection information between the tags and the advertisement. Then, the database 214 searches information of the advertisement connected to the provided tag information and provides the searched advertisement information to the advertisement searching unit 212 as a response. The database 214 may be configured to store the content of the advertisement itself. Alternatively, it may also be configured to store only the identification information of the advertisement. In the latter case, the advertisement itself may be maintained in a storage (not illustrated) separate from the database 214. The advertisement searching unit 212 can provide the searched advertisement to the client terminal 102 through the transmission unit 208.

The transmission unit 208 in accordance with the present embodiment may provide the user-created content, which is provided from the content reading unit 206, and the advertisement provided from the advertisement searching unit 212 to the client terminal 102. According to requirements, the transmission unit 208 may merge the user-created content and the advertisement. For example, when the user-created content is a cartoon (i.e., a picture) and the searched advertisement has an image format, the transmission unit 208 may append the searched advertisement image below the user-created content picture so as to provide them as one image file. In accordance with another embodiment, the transmission unit 208 may construct an HTML document so that the user-created content picture and the searched advertisement image are appropriately arranged in a page. As another example, when the user-created content has a moving picture format and the advertisement is also provided in a moving picture format, the transmission unit 208 may operate to merge the searched advertisement moving picture before the requested user-created content moving picture. Further, in accordance with another embodiment, the transmission unit 208 may add the advertisement moving picture and the user-created content moving picture in one play-list so as to provide them together. It would be appreciated by a person having ordinary skill in the art that any other easily conceivable method can be employed to merge the user-created content and the advertisement without departing from the spirit of the present invention.

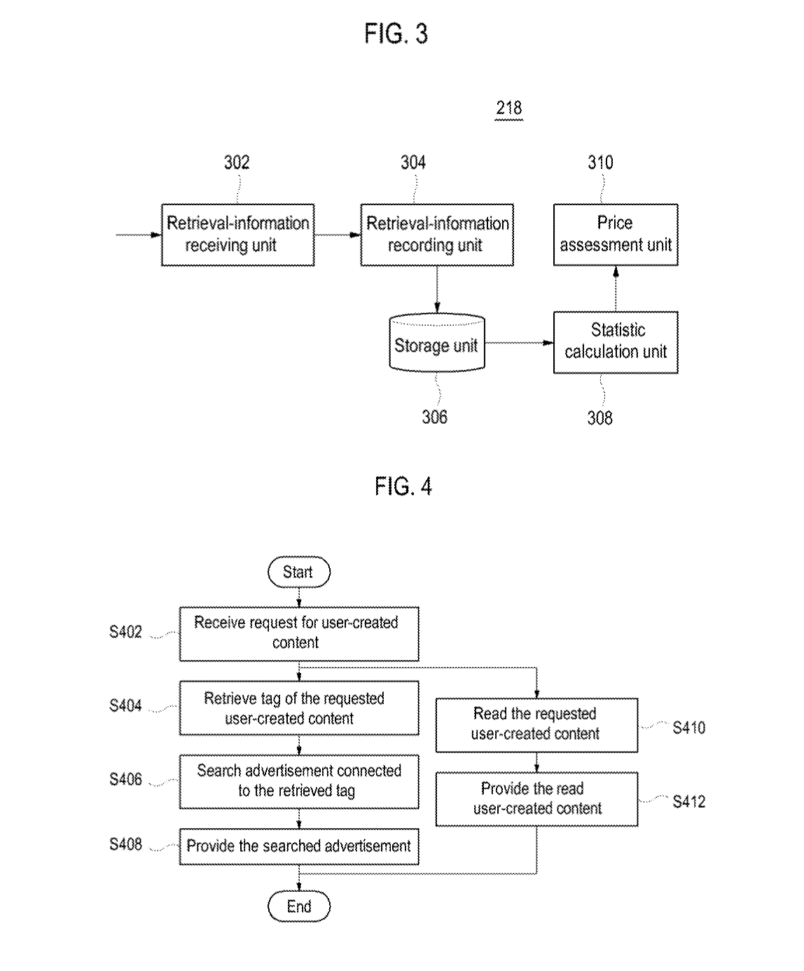

FIG. 3 shows a configuration of an advertisement statistic server in accordance with the first embodiment of the present invention. Referring to FIG. 3, the advertisement statistic server 218 includes: a retrieval-information receiving unit 302 that receives tag-retrieval information transmitted from the retrieval-information transmission unit 216; a retrieval-information recording unit 304 that records the received tag-retrieval information in a storage unit 306; and a statistic calculation unit 308 that calculates a statistic of the exposed tags based on the tag-retrieval records in the storage unit 306. The advertisement statistic server 218 may further include a price assessment unit 310 that assesses a price of advertisement for a tag based on the tag-exposure statistic calculated by the statistic calculation unit 308.

The price assessment unit 310 in accordance with the present embodiment may be configured to assess a higher advertisement price for a more frequently exposed tag. For example, the price assessment unit 310 may be configured to (when the “travel” tag has been exposed three times more than the “flower delivery” tag during the last one month) assess the advertisement price, which an advertiser should pay to attach an advertisement to the “travel” tag, to be three times as high as the advertisement price that an advertiser should pay to attach an advertisement to the “flower delivery” tag. However, it would be obvious for a person having ordinary skill in the art that the present invention is not limited to the present embodiment, and that any easily conceivable methods can be used to assess the advertisement price without departing from the spirit of the present invention. For example, the advertisement price can be assessed not in a flat rate but in a flexible manner. It is also possible to employ an auction in order to sell the advertisement to an advertiser who bids a higher price. Further, for this purpose, the price assessment unit 310 may be coupled with an advertisement selling system, which is not illustrated.

Although it has been described in the present embodiment that the advertisement statistic server 218 receives and records information of the retrieved tags and calculates the statistic for the tag-retrieval information, the present invention is not limited thereto. For example, the retrieval-information transmission unit 216 may be configured to transmit information of the advertisement, which is searched by the advertisement searching unit 212 and provided to the client terminal 102, instead of the tag-retrieval information. In such a case, the advertisement statistic server 218 may be configured to receive and record the information of the actually provided advertisement instead of the tag-retrieval information, and calculate a statistic of the actually provided advertisement. Further, rather than the price assessment unit 310 assessing the selling price of the advertisement in advance based on the calculated statistic, the price assessment unit 310 may be configured to operate to post-calculate compensation for providing the advertisement based on the statistic. That is, it may be configured to impose post payment in a manner that the cost for the advertisement varies according to the number of times the advertisement has been actually provided to a client terminal 102. Further, the price assessment unit 310 may be configured to assess a starting price based on the calculated statistic and allow competitive bidding on the starting price. The price assessment unit 310 may also be configured to operate in a manner that combines the above methods.

FIG. 4 shows an example of a method for providing advertisement in accordance with the first embodiment of the present invention. Referring to FIG. 4, the method for providing advertisement in accordance with the present embodiment first receives a request for user-created content from a client terminal (S402). Then, it retrieves tags of the requested user-created content (S404), searches advertisement connected to the retrieved tags (S406) and provides the searched advertisement to the client terminal (S408). The method for providing advertisement in accordance with the present embodiment also reads the requested user-created content from a storage unit (S410) and provides the read user-created content to the client terminal (S412).

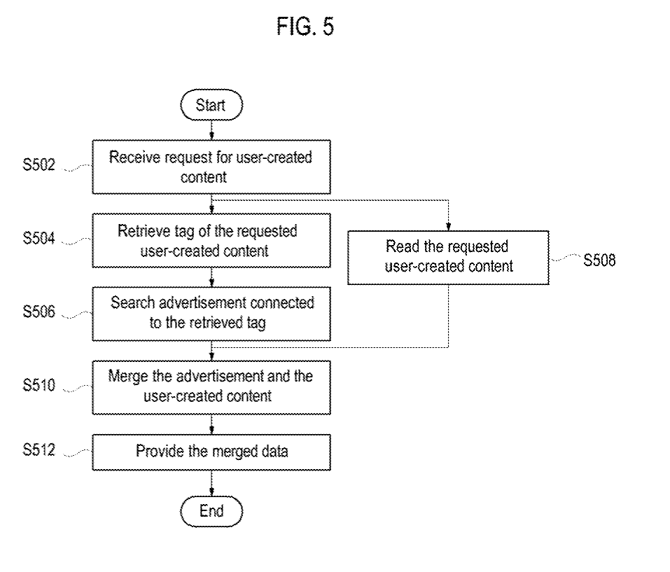

FIG. 5 shows another example of a method for providing advertisement in accordance with the first embodiment of the present invention. Referring to FIG. 5, the method for providing advertisement first receives a request for user-created content from a client terminal (S502). Then, it retrieves tags of the requested user-created content (S504), and searches advertisement connected to the retrieved tags (S506). The method for providing advertisement in accordance with the present embodiment also reads the requested user-created content from a storage unit (S508). Then, the method for providing advertisement in accordance with the present embodiment merges the advertisement searched at the step S506 and the user-created content read at the step S508 (S510). The merging may include, for example, putting the advertisement and the user-created content into one file. The method for providing advertisement in accordance with the present embodiment provides the merged data to the client terminal (S512).

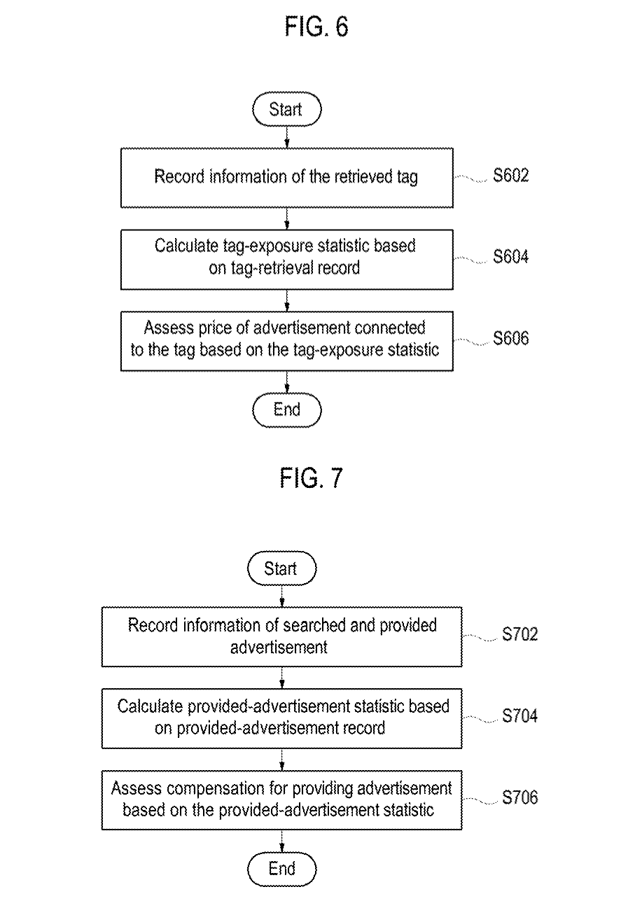

FIG. 6 shows an example of a routine related to an advertisement statistic in a method for providing advertisement in accordance with the first embodiment of the present invention. Referring to FIG. 6, the method for providing advertisement in accordance with the present embodiment records information of the retrieved tags (S602), calculates a tag-exposure statistic based on the recorded tag-retrieval records (S604) and assesses a price for the advertisement connected to a tag based on the calculated tag-exposure statistic (S606).

FIG. 7 shows another example of a routine related to an advertisement statistic in a method for providing advertisement in accordance with the first embodiment of the present invention. Referring to FIG. 7, the method for providing advertisement in accordance with the present embodiment records information of the advertisement that is searched and provided (S702), calculates a statistic of the provided advertisement based on the recorded provided-advertisement records (S704) and assesses compensation for providing the advertisement based on the calculated provided-advertisement statistic (S706).

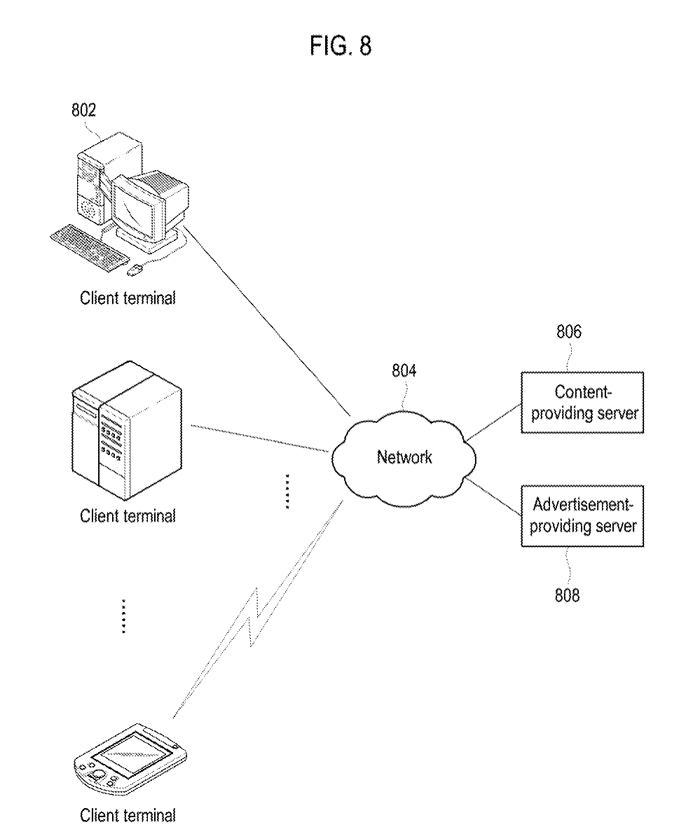

Although it has been described above as if the various components are included in the server system 106, it is not mandatory that all components are included in one server. On the contrary, they may be appropriately distributed in a plurality of servers, if required. For example, the content and the advertisement may be provided by separate servers or even by separate companies. FIG. 8 shows an exemplary network environment including client terminals and server systems in such a case.

Referring to FIG. 8, client terminals 802 communicate with a content-providing server system 806 and an advertisement-providing server system 808 through a network 804. The client terminals 802 are provided with user-created content from the content-providing server system 806 and are also provided with the advertisement related to the user-created content from the advertisement-providing server system 808. For this purpose, the client terminals 802 may include logics related to user-created content and advertisement. The advertisement-providing server system 808 may communicate with the content-providing server system 806 through the network 804 or through another connection mechanism that is not illustrated.

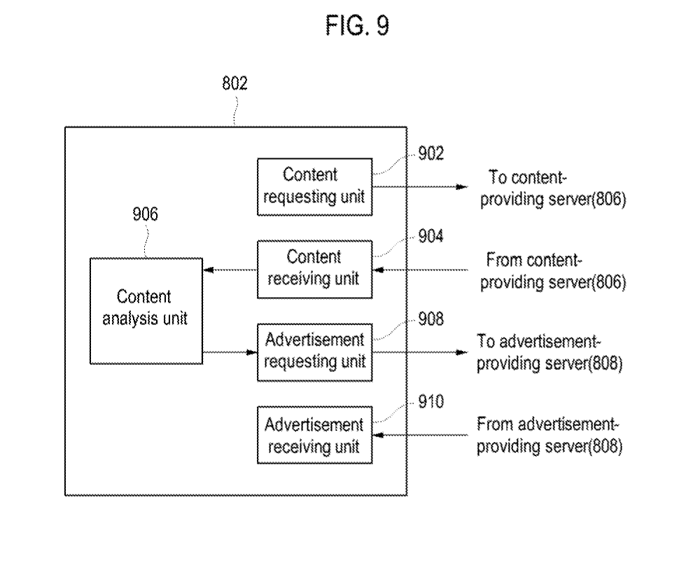

FIG. 9 shows a plurality of functional modules related to user-created content and advertisement in a client terminal in accordance with a second embodiment of the present invention. Referring to FIG. 9, a client terminal 802 includes: a content requesting unit 902 that transmits a request for user-created content to the content-providing server system 806; and a content receiving unit 904 that receives the user-created content transmitted from the content-providing server system 806. The client terminal 802 may further include: a content analysis unit 906 that analyzes the user-created content received at the content receiving unit 904 and extracts identification information to request an advertisement; an advertisement requesting unit 908 that requests an advertisement to the advertisement-providing server system 808 based on the extracted identification information; and an advertisement receiving unit 910 that receives the advertisement transmitted from the advertisement-providing server system 808.

The content analysis unit 906 in accordance with the present embodiment may be implemented by, for example, JavaScript, and may operate to extract a resource locator (e.g., URL) of the received content as the identification information. It may also provide the extracted resource locator to the advertisement-providing server system 808 through the advertisement requesting unit 908. In such a case, the advertisement-providing server system 808 provides the advertisement corresponding to the content based on the resource locator, which will be described later. However, the present invention is not limited to the resource locator. On the contrary, any information that can identify the advertisement related to the content can be used as the identification information. For example, the content analysis unit 906 may extract tags attached to the received content and may provide the extracted tag information to the advertisement-providing server system 808 through the advertisement requesting unit 908.

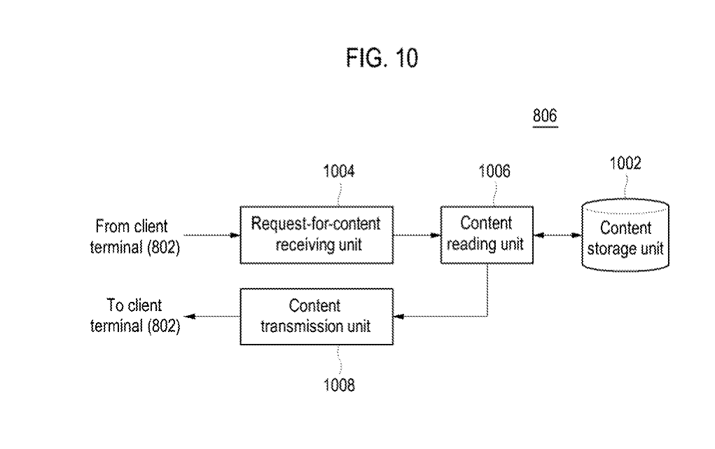

FIG. 10 shows a configuration of a content-providing server system in accordance with the second embodiment of the present invention. Referring to FIG. 10, the content-providing server system 806 includes a content storage unit 1002 that stores user-created content and a request-for-content receiving unit 1004 that receives a request for user-created content from a client terminal 802. The server system 806 further includes: a content reading unit 1006 that reads from the content storage unit 1002 the user-created content corresponding to the request received at the request-for-content receiving unit 1004; and a content transmission unit 1008 that transmits the user-created content, which is read from the content storage unit 1002 by the content reading unit 1006, to the client terminal 802 that requested the user-created content.

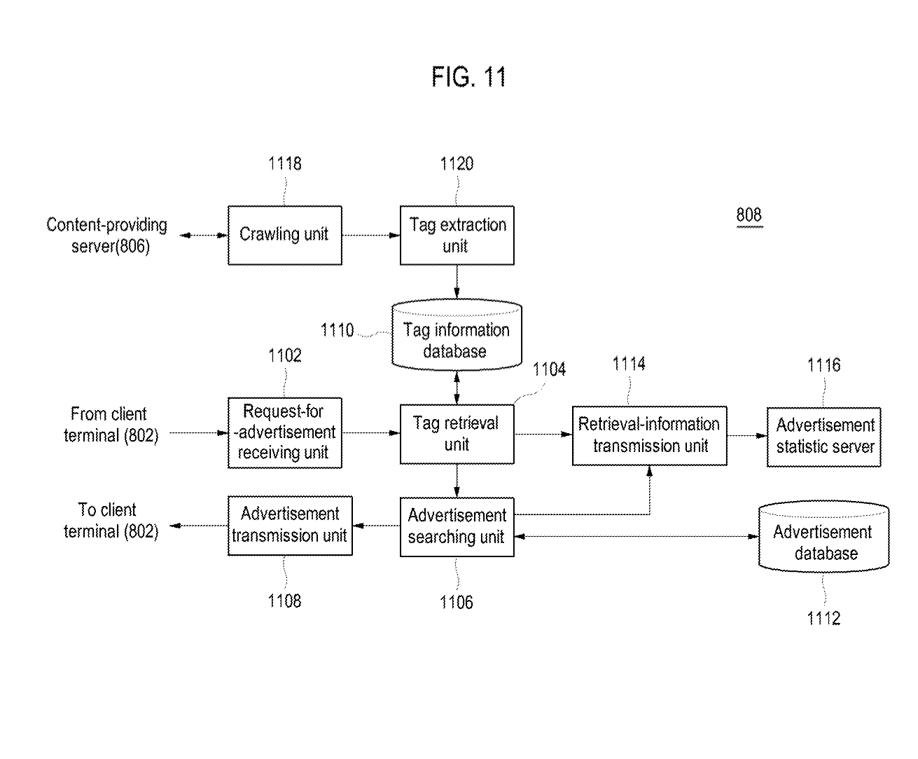

FIG. 11 shows a configuration of an advertisement-providing server system in accordance with the second embodiment of the present invention. Referring to FIG. 11, the advertisement-providing server system 808 includes: a request-for-advertisement receiving unit 1102 that receives a request for advertisement from a client terminal 802; and a tag retrieval unit 1104 that retrieves tags relevant to the identification information (for example, a resource locator) included in the request received at the request-for-advertisement receiving unit 1102. The advertisement-providing server system 808 further includes an advertisement searching unit 1106 that searches the advertisement corresponding to the tags retrieved by the tag retrieval unit 1104. The advertisement searched by the advertisement searching unit 1106 may be provided to the client terminal 802 by the advertisement transmission unit 1108.

In order to retrieve the tags relevant to the identification information, the tag retrieval unit 1104 may communicate with a tag information database 1110 that stores connection information between the identification information and the tag information. Further, in order to search the advertisement corresponding to the tags, the advertisement searching unit 1106 may communicate with an advertisement database 1112 that stores connection information between the tags and the advertisement. For the purpose of calculating a statistic related to providing the advertisement, the tag retrieval unit 1104 or the advertisement searching unit 1106 may provide information of the retrieved tags or information of the searched and provided advertisement to an advertisement statistic server 1116 through the retrieval-information transmission unit 1114. Although components including the advertisement database 1112, the advertisement statistic server 1116 and the like are illustrated as being included in the advertisement-providing server system 808, it is also possible to locate them out of the advertisement-providing server system 808, if required. To create and update the tag information database 1110, the advertisement-providing server system 808 may further include a crawling unit 1118 that performs crawling of content from the content-providing server system 806 and a tag extraction unit 1120 that extracts tags from the crawled content.

The crawling unit 1118 in accordance with the present embodiment establishes a connection to the content-providing server system 806 to perform the crawling of content and provides the crawled content to the tag extraction unit 1120. The tag extraction unit 1120 analyzes the crawled content, extracts tags appropriate for the crawled content, connects identification information (e.g., a resource locator) of the crawled content with the extracted tags and stores the connection information in the tag information database 1110. This makes it possible to provide the advertisement appropriate to the content even when only identification information of the content is provided from the client terminal 802. The connection information can be stored in, for example, a hash format with using the resource locator as a key. However, the present invention is certainly not limited thereto. Then, the tag retrieval unit 1104 may use the connection information stored in the tag information database 1110 to retrieve the tag information based on the content identification information received at the request-for-advertisement receiving unit 1102.

Although one content-providing server system 806 has been described as an example in the present embodiment, the present invention is not limited thereto. On the contrary, a plurality of content-providing server system can be used. Further, it has been described in the present embodiment that the request-for-advertisement receiving unit 1102 receives the request for advertisement from the client terminal 802. However, the present invention is not limited to a device that is directly controlled by a user. The request-for-advertisement receiving unit 1102 may process requests from any clients including, for example, a middleware or even another server. The crawling unit 1118 may maintain a list of content-providing server systems to which the crawling is to be performed. The crawling unit 1118 may be configured to connect to the content-providing server systems to crawl the content at a predetermined time, for example, in a regular time interval.

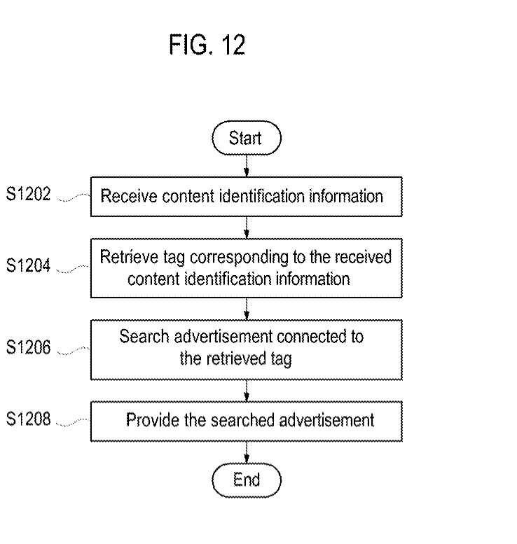

FIG. 12 shows a method for providing advertisement in accordance with the second embodiment of the present invention. Referring to FIG. 12, the method for providing advertisement in accordance with the present embodiment first receives content identification information from a client terminal (S1202) and retrieves tags corresponding to the received content identification information (S1204). Then, it searches advertisement connected to the retrieved tags (S1206) and provides the searched advertisement to the client terminal (S1208).

The steps in the aforementioned methods for providing advertisement are not necessarily performed in the illustrated order. The order can be adjusted without departing from the spirit of the present invention. Further, the methods for providing advertisement of the present invention may be implemented as a computer-executable program, firmware, hardware and the like. The program may be recorded in a computer-readable medium.

In the above embodiments, it has been described that particular user-created content are requested by a client terminal. However, it would be appreciated by a person having ordinary skill in the art that the present invention is not limited thereto. That is, any requests that can have relevancy with tags can also be used. For example, a user may input keywords to request a search for user-created content. In such a case, the server system may be configured to extract tag information based on the keywords inputted for the search and then to provide the relevant advertisement.

In accordance with the present invention, there are provided systems and methods for providing advertisement in connection with tags of user-created content. Thus, it is possible to provide advertisement having higher relevancy with the content. Further, even for content that includes non-text information, it is also possible to provide advertisement having relevancy with the content.

While embodiments of the present invention have been shown and described to facilitate the understanding of the present invention, the present invention is not limited to the specific embodiments described in this disclosure, as can be appreciated by a person of ordinary skill in the art. Therefore, various changes and modifications may be made without departing from the spirit and scope of the present invention as defined in the appended claims.

1. A system for providing advertisements in connection with tags of user-created content, comprising:
a request receiving unit configured to receive a request for user-created content from a client terminal, wherein the user-created content includes non-text information;
a content reading unit configured to read the user-created content according to the received request;
a tag retrieval unit configured to retrieve tags of the read user-created content;
an advertisement searching unit configured to search advertisements connected to the retrieved tags; and
a transmission unit configured to transmit the read user-created content and the searched advertisements to the client terminal.

2. The system of claim 1, wherein the tag is maintained as a separate data distinguished from a body of the user-created content.

3. A system for providing advertisements in connection with tags of user-created content, comprising:
a request-for-advertisement receiving unit configured to receive a request for advertisements related to user-created content from a client, wherein the user-created content includes non-text information;
a tag retrieval unit configured to retrieve tags of the user-created content based on the received advertisement request;
an advertisement searching unit configured to search advertisements connected to the retrieved tags; and
a transmission unit configured to transmit the searched advertisements to the client.

4. The system of claim 3, further comprising:
a tag information database configured to store connection information between identification information of the user-created content and the tags of the user-created content,
wherein the advertisement request includes the identification information of the user-created content, and
wherein the tag retrieval unit is configured to retrieve the tags that are connected to the identification information in the tag information database.

5. The system of claim 4, wherein the identification information is a resource locator of the user-created content.

6. The system of claim 4, further comprising:
a crawling unit configured to perform crawling of the user-created content; and
a tag extraction unit configured to extract tags by analyzing the crawled user-created content and to store result of the extraction in the tag information database.

7. The system of claim 3, wherein the advertisement request includes the tags of the user-created content, and
wherein the tag retrieval unit is configured to extract the tags from the advertisement request.

8. The system of claim 1, wherein the tags include system tags.

9. The system of claim 1, further comprising:
an advertisement database configured to store connection information between the tags and the advertisements,
wherein the advertisement searching unit includes:
a database interface unit configured to provide the retrieved tags to the advertisement database and to receive information of the advertisements connected to the tags from the advertisement database.

10. The system of claim 1, further comprising:
an advertisement statistic server configured to calculate a statistic related to providing of the advertisements.

11. The system of claim 10, further comprising:
a retrieval-information transmission unit configured to transmit information of the retrieved tags to the advertisement statistic server,
wherein the advertisement statistic server includes:
a retrieval-information receiving unit configured to receive the tag-retrieval information transmitted from the retrieval-information transmission unit;
a retrieval-information recording unit configured to record the tag-retrieval information received at the retrieval-information receiving unit; and
a statistic calculation unit configured to calculate a tag-exposure statistic based on the records recorded by the retrieval-information recording unit.

12. The system of claim 11, further comprising:
a price assessment unit configured to assess prices of the advertisements connected to the tags based on the calculated statistic.

13. The system of claim 10, further comprising:
a provided-advertisement-information transmission unit configured to transmit information of the provided advertisements to the advertisement statistic server,
wherein the advertisement statistic server includes:
a provided-advertisement-information receiving unit configured to receive the provided-advertisement information transmitted from the provided-advertisement-information transmission unit;
a provided-advertisement-information recording unit configured to record the provided-advertisement information received at the provided-advertisement-information receiving unit;
a statistic calculation unit configured to calculate a statistic of the provided advertisements based on the records recorded by the provided-advertisement-information recording unit; and
a compensation assessment unit configured to assess compensation for providing the advertisements based on the calculated provided-advertisement statistic.

14. The system of claim 1, wherein the transmission unit includes:
a merging unit configured to merge the read user-created content and the searched advertisements.

15. A client terminal configured to receive advertisements connected to tags of user-created content, comprising:
a content requesting unit configured to request for user-created content to a first server, wherein the user-created content includes non-text information;
a content receiving unit configured to receive the requested user-created content;
an advertisement requesting unit configured to request for advertisements related to the received user-created content to a second server; and
an advertisement receiving unit configured to receive the advertisements related to the user-created content.

16. The client terminal of claim 15, further comprising:
a content analysis unit configured to extract identification information of the received user-created content,
wherein the request for the advertisements includes the extracted identification information.

17. The client terminal of claim 16, wherein the identification information is a resource locator of the user-created content.

18. A method of providing advertisements in connection with tags of user-created content, comprising:
receiving a request for user-created content from a client terminal, wherein the user-created content includes non-text information;
retrieving tags of the requested user-created content;
searching advertisements connected to the retrieved tags; and
providing the searched advertisements to the client terminal.

19. The method of claim 18, wherein the tag is maintained as a separate data distinguished from content of the user-created content.

20. A method of providing advertisements in connection with tags of user-created content, comprising:
receiving a request for advertisements related to user-created content from a client, wherein the user-created content includes non-text information;
retrieving tags of the user-created content based on the received advertisement request;
searching advertisements connected to the retrieved tags; and
providing the searched advertisements to the client.

21. The method of claim 20, wherein the advertisement request includes identification information of the user-created content, and
wherein the tag-retrieving step retrieves the tags based on the identification information of the user-created content.

22. The method of claim 21, wherein the identification information is a resource locator of the user-created content.

23. The method of claim 20 wherein the tags include system tags.

24. The method of claim 20 further comprising:
recording information of the retrieved tags; and
calculating a tag-exposure statistic based on the tag-retrieval records.

25. The method of claim 24, further comprising:
assessing prices of the advertisements connected to the tags, based on the calculated tag-exposure statistic.

26. The method of claim 20 further comprising:
recording information of the provided advertisements;
calculating a provided-advertisement statistic based on the records of the provided advertisements; and
assessing compensation for providing the advertisements, based on the calculated advertisement-provision statistic.

27. The method of claim 18 further comprising:
merging the requested user-created content and the searched advertisements.

28. The method of claim 27, wherein the merging step includes:
putting the requested user-created content and the searched advertisements together into one file.

29. Logic encoded in one or more tangible media for execution and when executed operable to cause the one or more processors to:
receive a request for user-created content from a client terminal, wherein the user-created content includes non-text information;
retrieve tags of the requested user-created content;
search advertisements connected to the retrieved tags; and
provide the searched advertisements to the client terminal.
